(19) United States
(12) Patent Application Publication
(10) Pub. No.: US 2022/0398664 A1
(43) Pub. Date: Dec. 15, 2022

(54) METHOD AND SYSTEM FOR ADMINISTERING AND FINANCING INVESTMENT CONTRACTS AND INSTRUMENTS

(71) Applicant: Lorry James STENSRUD, Lake Forest, IL (US)

(72) Inventor: Lorry James STENSRUD, Lake Forest, IL (US)

(21) Appl. No.: 17/777,190

(22) PCT Filed: Nov. 30, 2020
(86) PCT No.: PCT/US20/62607

§ 371 Date: May 16, 2022

Related U.S. Application Data
(60) Provisional application No. 62/942,429, filed on Dec. 2, 2019.
(60) Provisional application No. 63/037,036, filed on Jun. 10, 2020.

(51) Int. Cl. G06Q 40/06; G06Q 40/08

(52) U.S. Cl. CPC G06Q 40/06; G06Q 40/08

(57) ABSTRACT

A machine-learning based system configured to optimize investment returns for a revenue generating investment based on retirement benefit plan information, the machine-learning based system comprising a server, the server including one or more processors and one or more memories, the server configured to receive, via a computer network, one or more investment requests of a user, and profile information of the investment, wherein the server is further configured to generate or update an investment profile for the investment, wherein the investment profile is associated with, in the one or more memories, the one or more search investments. A first machine-learning component configured to execute on the one or more processors of the server, the machine-learning component further configured to train a machine learning model using a machine-learning feature dataset comprising each of: projected operating revenue information, projected operating cost information and projected investment need information, to generate, with the machine-learning feature dataset, each of (1) net return and (2) a machine-learning ranking of the investment. A second machine-learning component configured to execute on the one or more processors of the server, the machine-learning component further configured to train a machine learning model using a machine-learning feature dataset comprising each of: pension plan data and beneficiary medical data, to generate, with the machine-learning feature dataset, each of (1) tranches of cohorts of beneficiaries and (2) a machine-learning analysis of the benefit stream needed to meet the payments to each tranche of cohorts. An optimization component configured to execute on the one or more processors of the server, the optimization component further configured to receive updated operating revenue information and updated operating cost information to generate updated net earnings and updated net investment return information. wherein the generation of the updated net earnings and updated net investment return information causes the server, to transmit, via the computer network, the updated plan information to a user.

### FIELD OF THE INVENTION

This invention generally relates to methods and systems for administering and financing contracts and instruments for long-duration investments and for retirement income. The invention incorporates the use of artificial intelligence and machine learning to improve and optimize predictions of anticipated revenue and expected returns of various investments. Specifically, this invention relates to methods and systems for administering and financing contracts and instruments for large, long-duration revenue-generating investments, such as investments in large infrastructure projects.

### BACKGROUND OF THE INVENTION

There exists an urgent need for obtaining long-duration funding for large infrastructure projects in America and throughout the world. Traditionally, government funding has been relied upon to finance such large projects. To date, private funding has been expensive, and no systems are in place that satisfactorily provide private investors with a reasonable assurance of an expected return.

Large potential infrastructure projects such as locks, dams, roads and bridges often generate revenues from tolls or fees, for example, that may be used to secure funding for the projects from governments and/or financial entity investors, such as insurance companies, banks and private equity funds.

While there are many potential sources of private funding for such projects, typically such sources seek long-duration investments without project management and infrastructure operational responsibilities. For example, U.S. pensions are believed to have $120 trillion in assets under management and are looking for solid long-duration investments with the potential to generate yields sufficient to meet the benefits promised their participants. Such long-duration investments (e.g., 15-20 years) may help reduce defined benefit plan and/or pension fund liabilities.

Demand for long-duration assets has increased. In a low interest rate environment, the present value of future pension liabilities increases, requiring more current funding. Combined, U.S. corporate and government pension funds are underfunded by more than $1 trillion, according to figures from the Pension Benefit Guaranty Corporation and a recent report from the Cato Institute. Projections of rapidly aging and longer-living populations in most OECD countries indicate that the demand for long-duration investments will only grow.

Regulatory developments add to this trend through stricter asset-liability matching regulations governing pension funds and new risk-based regulations for insurance companies. Likewise, new international accounting standards reinforce the need for pension funds to match assets with long-term liabilities. Simultaneously, most OECD governments, including the U.S., have actually reduced debt maturities to 10-years and under, while pension and life insurance liabilities often exceed 15 years.

However, certain types of long-duration infrastructure investments are avoided due to unfavorable tax treatment, or reticence and inability to manage the projects or to operate and maintain the asset. For example, direct investment by corporate pension funds into longer-duration infrastructure activities can trigger Unrelated Business Income Tax (UBIT) exposure and therefore are avoided.

### SUMMARY

These and other needs are addressed by the present invention, in which high-alpha, non-correlated, long-duration funding can be secured through specially designed non-registered exempt securities that use life insurance company “Separate Accounts” whose underlying portfolios can invest broadly in infrastructure without triggering UBIT penalties. As used herein, a Separate Account is a fund held by a life insurance company that is maintained separately from the insurer's general assets.

In addition, a Surplus Account associated with the investment is created. The Surplus Account may be used as a hedge against risk of the investment not making minimum expected returns in a given period, as described in more detail herein.

One aspect of the present invention stems from the realization that there is a need to unlock access to infrastructure investment opportunities offering high-alpha, non-correlated expected returns with durations far longer than the investment horizons of typical alternative investment structures employed by Pensions, such as Private Equity, SPACs, CxOs, etc.

The advisor of an insurance company Separate Account may acquire, or fund the building or repair of, infrastructure projects. The beneficiary of the infrastructure project, whether a governmental entity or private company, may reclaim the asset at the end of the contract.

It is an objective of this invention to provide a system and method for efficiently implementing an investment structure for large projects, such as infrastructure projects, as a long-duration asset (e.g., 15-25 years or longer) on an efficient basis.

As set forth herein, the eligible investors, which typically are private or public pension funds or sovereign wealth funds, may provide an initial level of funding in return for a stated minimum return over a stated number of years. Government or quasi-government entities (public sector) may augment the private sector investments with various types of additional capital, including loans, direct funding and guarantees. A mechanism may be provided such that at some future date, the project can revert back to the public sector.

In addition to the long-term funding solutions, this invention implements these solutions through the use of artificial intelligence and machine learning to create better models that estimate expected returns for such revenue generating infrastructure projects as well as for other investments such as insurance contracts or annuities that generate retirement income better suited for the recipient(s) of the resultant payments. The improved model can be used to create more efficient investments that allow plans to reduce underfunding with higher returns and to help lower amounts needed to meet payouts when returns are above plan return guidelines.

Other advantages of the present invention will become readily apparent from the following detailed description. The invention is capable of other and different embodiments, and its several details are capable of modifications in various obvious respects, all without departing from the invention. Accordingly, the drawing and description are illustrative in nature, not restrictive.

### BRIEF DESCRIPTION OF THE DRAWINGS

The foregoing aspects and many of the attendant advantages of the disclosed embodiments will become more readily appreciated by reference to the following detailed description, when taken in conjunction with the accompanying drawings, wherein:

FIG. 1 is a flow diagram illustrating an example of various aspects of a machine-learning platform useful in this invention.

FIG. 2 is a flow diagram illustrating long-duration investment methodology that can be implemented using a machine-learning platform.

FIG. 3 depicts a flowchart for implementing an exemplary method for collecting data in the context of a long-duration investment and methodology that can be implemented using a machine-learning platform.

FIG. 4 depicts a flowchart illustrating exemplary aspects of a project eligibility assessment based on a machine-learning platform.

FIG. 5 depicts a flowchart illustrating exemplary aspects of a policy form customization based on a machine-learning platform.

FIG. 6 depicts a computer system that can be used to implement an embodiment of the present invention.

### DETAILED DESCRIPTION

A methodology for administering and financing contracts and instruments for long-duration investments is described. The invention uses artificial intelligence or a machine-learning component that may be trained, or otherwise configured, to predict and evaluate, based on various data about the investment, expected returns from various revenue generating investments, and anticipated payment streams required to meet investors and other parties' retirement income benefits, given the aforementioned expected revenue streams and investment returns. In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

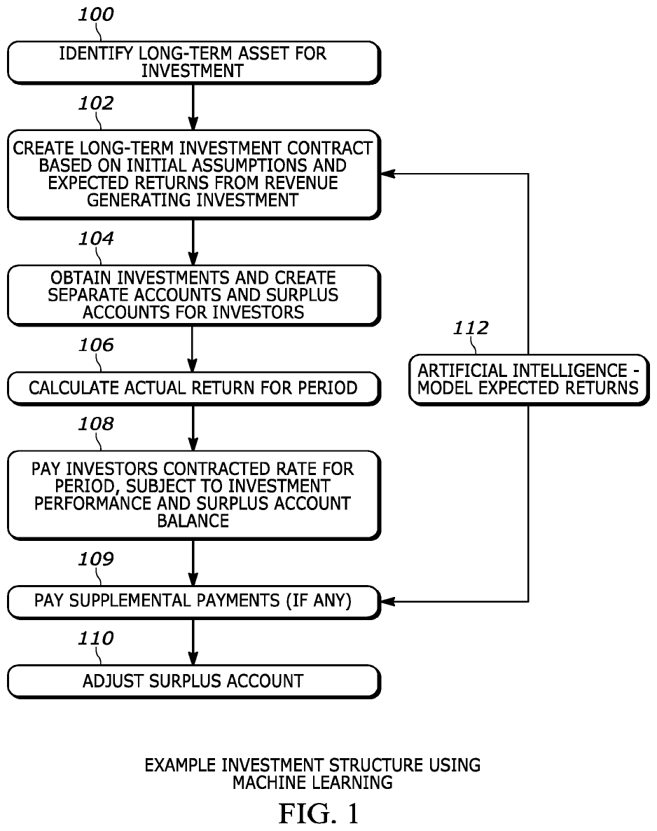

The operation of embodiments of the present invention is illustrated with respect to an exemplary investment structure 100 shown in FIG. 1. The present invention is not limited to the exemplary investment structure shown in FIG. 1, but is capable of application to other structures. The discussion will now turn to FIG. 1, which is a block diagram illustrating the methodology for a long-duration investment.

A long-duration asset is identified for potential investment (100). The asset may be a large infrastructure asset that generates revenue, such as toll bridge, a toll road or lock system. Such assets usually require large amounts of funding in order to carry out large projects, including building/construction, expansion, improvements or repairs. These assets also generate revenue, for example through tolls, user fees or taxes.

Once a suitable investment is identified, a contract is created for an investment in the asset based on initial assumptions about the expected returns over a period of time (102). The expected returns can be based on a number of factors and assumptions of those factors at the time the investment is being offered. The investment contract may be a long-duration contract, e.g., 15-20 years, that pays guaranteed returns periodically during the term. The factors and assumptions used to generate the expected returns may include a number of factors described in more detail below, but may include the results of modeling of data using a machine-learning component that is trained, or otherwise configured, to predict revenues and expenses associated with the project, based on the data that may be received from multiple sources on a historical and real time basis.

Investments are obtained from eligible investors seeking to realize the expected returns. In order for certain types of eligible investors to invest, the contract may be offered through Separate Accounts created for one or more investors at an insurance company (104). The Separate Account allows investors to participate in long-duration infrastructure funding opportunities through specially designed, non-registered exempt securities. Because of the use of life insurance company Separate Accounts, the underlying portfolios may invest broadly without triggering UBIT penalties. Further, it is the investment advisor of the Separate Account that must manage and operate the projects either directly or through the employment of qualified third-parties, thereby relieving the investor of such responsibilities.

In addition, a Surplus Account associated with the investment is created. Funds credited to the Surplus Account may be used as a hedge against risk of the investment not making minimum expected returns in a given period, or as a source of supplemental returns as described in more detail herein.

Periodically, the actual return of the investment is determined (106) and investors are paid their return per the contract, subject to the investment's performance and the Surplus Account balance (108). Supplemental payments may be made to investors or other parties upon certain conditions (109). The Surplus Account is also adjusted based on the actual returns for the period and any supplemental payments (110). As described below in more detail, the Surplus Account may be increased if the actual returns are greater than the return to be paid to investors and any supplemental payment. On the other hand, the Surplus Account may be decreased if it is used to fund a shortfall in revenue needed to pay the required return in a period or if it used to make, on certain conditions, a supplemental payment to be distributed to the investors or other parties as described herein. An example of the operation of a Surplus Account in the context of an immediate variable annuity is described in U.S. Pat. No. 8,762,245, which is hereby incorporated herein by reference. The Surplus Account in this invention functions generally similarly as described therein, but there are differences, which are described herein, due to the context of an investment for a long-duration investment using Separate Accounts and various third-parties and potential supplemental payments.

A machine-learning component may be trained, or otherwise configured, based on machine learning models trained on various data that has been collected, to generate the initial investment terms (112). For example, a machine-learning component may be trained, or otherwise configured, to predict, based on numerous types of relevant data that has been collected and is available at the time of the contract, net operating revenue, net operating costs, net earnings, net investment needs and net returns for the investment. The machine-learning component can also be trained or configured to predict future expected revenues for the project, throughout the term of the investment, based on updated and real time data from a variety of sources, as described below. The updated future revenue predictions can be used to determine whether or how to make any supplemental payments and whether funds can be disbursed from the Surplus Account for a supplemental payment (112).

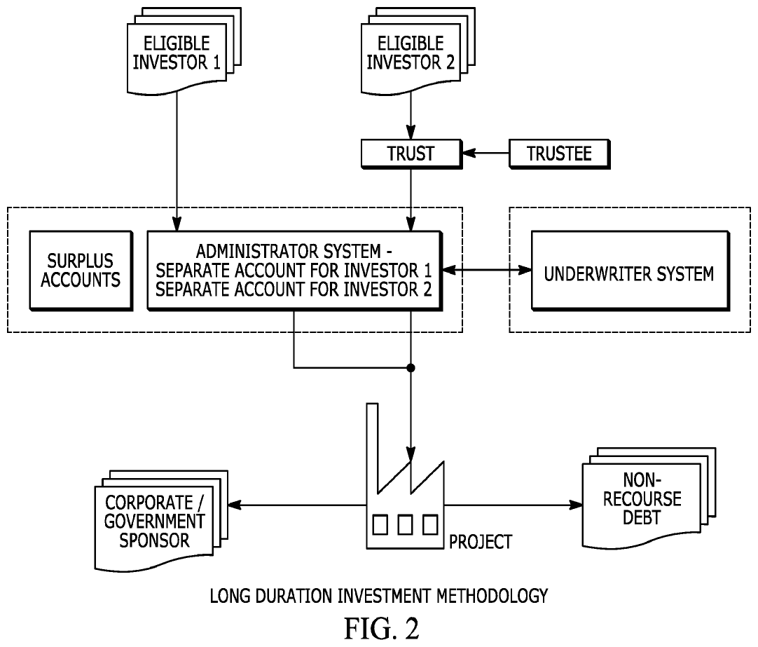

FIG. 2 shows an example of the methodology and structure for a long-duration investment in a project for an asset that generates revenue, such as a toll bridge or toll road or a lock system on a river. Each of these types of assets may be in need of funding for reconstruction or repair or funding to be built or expanded. Because each of these types of assets generates long-duration streams of revenue, a large investment in the project may be able to be based on those revenues to provide long-duration returns that meet the investors' objectives. The revenue may change over time based on a number of factors, and therefore the long-duration investment contract can reflect the possibility of such changes by providing additional returns to the investors or other parties. These types of investment are generally considered high-alpha, non-correlated, long-duration investments.

The exemplary methodology and structure for the long-duration investment may include, for purposes of explanation, one or more eligible investors. The investors may be long-duration investors seeking investments that may return a steady stream of revenue over a long period of time, e.g., 15 to 20 years. For example, a first eligible investor may be a government pension plan or sovereign wealth fund that invests directly in the investment. A second eligible investor may be a pension plan or a group of pension plans that invest through an associated group trust. A trustee may also be associated with the trust.

The eligible investors may invest with an administrator such as an insurance company. The eligible investors have Separate Accounts at the administrator. The Separate Accounts can be invested, based upon instruction of the administrator (e.g., insurance company), into an asset such as an infrastructure project to maintain or repair a toll bridge. Other projects that may be invested in include toll road, lock system, or any other revenue producing asset.

A beneficiary or sponsor may be a corporate or governmental entity that owns or has the obligation and/or right to improve or build the structure and/or receive income from the structure to be improved or built. The role of the sponsor may be to sell or lease the asset to the Separate Account, transfer claims to revenues generated by the asset to the Separate Account and to provide ongoing support in the maintenance or operation of the infrastructure asset.

An insurance company underwriter may provide information relating to the structure and terms of the investment contract based on actuarial data and models used to estimate such things as the revenues and returns for the project and cashflows needed to meet the pension liabilities or plan participant retirement benefits for the investment.

In addition to funds sourced from investors, non-recourse debt may also be associated with the initial capitalization of the project. Such non-recourse debt may include various types of funding, including loans, direct funding and guarantees by governments or other quasi-government entities.

In this example, generally, the investors invest in the Separate Accounts of an insurance company. The Separate Accounts own the infrastructure project. While the investors will work with the insurance company to set some level of return expectation, the Separate Accounts may not offer any guarantees of return to the investors, therefore minimal regulatory reserves are required by the insurance companies

The Separate Accounts may also contract with a third-party (not shown) to build or repair the bridge, provide on-going maintenance and to collect tolls that are used to generate the returns to the investors.

Predicted expected returns for the investment are initially based on data and other information known at the time the investment occurs, such as expected revenues from tolls on the bridge once it is repaired, given usage by various types of vehicles over a set time period. Generally, such expected returns used are based on amounts that are lower than the actual expected revenues in order to ensure commitments for minimum returns can be met.

In the event actual revenue increases beyond those set out in the contract, e.g., due to increased usage, increased toll revenue or lower costs of operation, the present system allows the project to adjust its payout structure dynamically. At regular intervals, payments due investors are calculated based on overall revenue received for the period. Some or all of the revenue generated goes to investors as contracted. Should there be excess revenue over and above that required to meet the contracted return to the investor, this amount may be credited to the Surplus Account. The amounts in the Surplus Account may be used to supplement the return of the investor or to compensate the sponsor or other third-parties as stipulated in the investment contract. It is anticipated that the sponsor may then use the unanticipated revenue for other ongoing infrastructure maintenance, repair or construction outside the contracted project.

With this methodology, a long-duration asset is created for the investor (e.g., pension plan) to off-set the pension plan's long-duration pension liabilities

### Example

For example, for an investment structure described above, the expected returns (Ret_{E}) for the investors may be set at 7% annually for a term (T) of 20 years. The expected returns (Ret_{E}) may be based on initial annual revenue projections for the term of the investment (T). The initial revenue projections may be done for the entire term or a subset of the investment term (T), e.g., for revenue on annual basis. In another example, the expected returns for the investment may vary. For example, the expected returns (Ret_{E}) for years 1-5 of the term may be 3% and the expected returns for years 5-20 may be (9%). The difference in returns may be set, for example, based on expected revenue projections that are lower for years 1-5 and greater for years 6-10. The initial expected returns can be set in a number of different ways based on the initial revenue projections. The expected returns (Ret_{E}) and expected revenue projections may be based on machine learning as described in more detail below.

Also, as an example, for a given time period (P), the actual return (Ret_{A}) is determined. If the actual return (Ret_{A}) for a period is equal to the expected return (Ret_{E}) for that period, then the investors are paid the expected return (Ret_{E}) and no adjustment to the Surplus Accounts are needed.

If the actual return (Ret_{A}) for a period is greater than the expected return (Ret_{E}) for that period, then the investor is paid the expected return (Ret_{E}). The difference between the actual return (Ret_{A}) and the expected return (Ret_{E}) may be added to the Surplus Account (Account_{Surplus}) associated with the investor's Separate Account (Account_{Separate}).

If the actual return (Ret_{A}) for a period is less than the expected return (Ret_{E}) for that period, then the system checks to see if there is a positive balance in the investor's Surplus Account (Account_{Surplus}). If there is a positive balance, the amount of the balance is compared to the difference between the actual return (Ret_{A}) and the expected return (Ret_{E}). If the balance of the Surplus Account is greater than or equal to the difference between the actual return (Ret_{A}) and the expected return (Ret_{E}), then the investor is paid the expected return (Ret_{E}) and the Surplus Account may be used to pay the difference and is decreased by the difference between the actual return (Ret_{A}) and the expected return.

If the balance of the Surplus Account is positive, but less than the difference between the actual return (Ret_{A}) and the expected return (Ret_{E}), then the investor is paid an amount equal to the actual return (Ret_{A}) and the amount in the Surplus Account. The Surplus Account is then set to zero.

The combinations of increases to the Surplus Account or decreases from the Surplus Account can be varied and may include allowing the Surplus Account to go negative.

One possibility is to cap the amount of the Surplus Account. For example, if the amount of the actual returns greatly exceeds expected returns, and the amount of the Surplus Account becomes greater than 5% of the initial investment, a special distribution may be made from the Surplus Account that reduces the amount to 5%. The special distribution may be made, in whole or in part, to the investors, the sponsors, the administrator or another third-party.

In another version, the investment could be tuned by the machine learning component to help with investors that have increasing payment obligations, e.g. pension payment obligations to retirees that are entitled to a 3% annual increase in pension payments to its retirees. In this example a revenue model may be based on toll revenue from estimated traffic. For example, the actual traffic is 42,000 vehicles a day, but the model uses a reduced number for purposes of calculating contracted returns e.g., 35,000 vehicles per day, with the expectation that the actual revenue should exceed that of the model. Thus, with the actual return greater than the expected return, the Surplus Account should grow with traffic at 42,000 a day. If the estimate for the model is further reduced to 30,000 vehicles a day, the Surplus Account would grow even faster. This modeling would be easier for the pension to meet an obligation to pay a 3% annual increase in income. The administrator could also work with the project sponsors (in this case the state) to negotiate a toll increase that would meet the future income needs of retired pension plan participants.

A key to the invention is having employee data from the pension so the investment advisor has accurate information about how to customize versions of the investment to meet pension fund liabilities. Data may come from public or corporate pension funds. Data could include plan data, employee data, age, income at retirement, funds needed to support the income at retirement, medical information and plan payout options. Additional data could come from plan sponsors, pension trustees, pension consultants, unions, or asset managers involved in the project or investment.

The machine-learning component may be trained, or otherwise configured, to predict, based on various data, what percent of each project's return should be used for accumulation or for income. The data can also be modeled to help refine the offering terms of the income product structure.

All of the data can be used to model the Surplus Account, the amounts to be maintained in the Surplus Account and how funds in the Surplus Account are to be used and/or drawn down for payout. The potential is to help reduce underfunding with higher return investments and to help reduce dollars required to fund benefit payouts as our returns are above plan return guidelines.

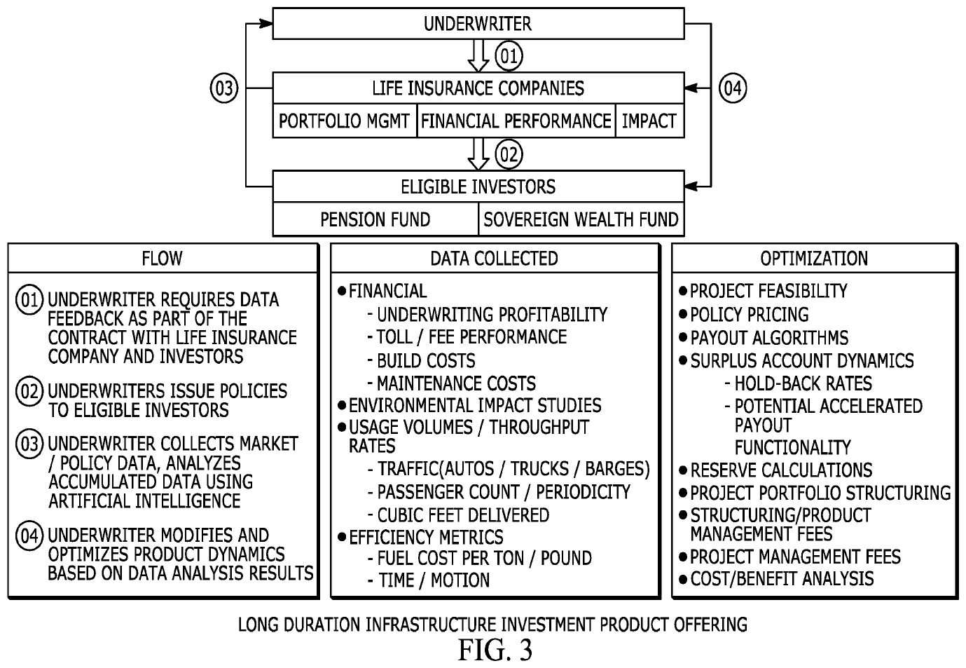

FIG. 3. shows the process, in the context of a long-duration investment, for collecting data, the types of data that can be collected. A machine-learning component may be trained, or otherwise configured, to predict, based on machine learning models trained on various data that has been collected, to optimize the investment's revenue streams and new investment returns.

In the context of the long-duration investment, the administrator can also use a machine-learning component that is trained, or otherwise configured, based on machine learning models trained on various data that has been collected, to conform projects based on the specifics of various plans. For example, some projects may require increases tied to inflation, some may have fixed percentage automatic increases, some have no increases in order to match retirement payout benefit obligations. At any time, the administrator would know the pool of employees that are retiring across a broad spectrum of plans and could design projects to conform to the employee base that is retiring. This could also be done by industry or job focus. As an example, police have a shorter life expectancy.

Pension Liability Management

Further, pension plan sponsors and pension plan advisors can provide information that allows an administrator to identify policy forms and Separate Account structures that minimize Plan ALM mismatches for public record. Data regarding the nature of Plan obligations is collected and modeled in comparison to alternative policy forms in order to optimize outcomes.

For life companies that are very active in the pension buyout space this methodology could be used to improve their bidding process and then eventually their payout. The data as used in continuous modeling by the machine learning component would help life companies know how much they need to buy each year in order to meet income requirements of retiring employees.

### Example—Project Eligibility Model

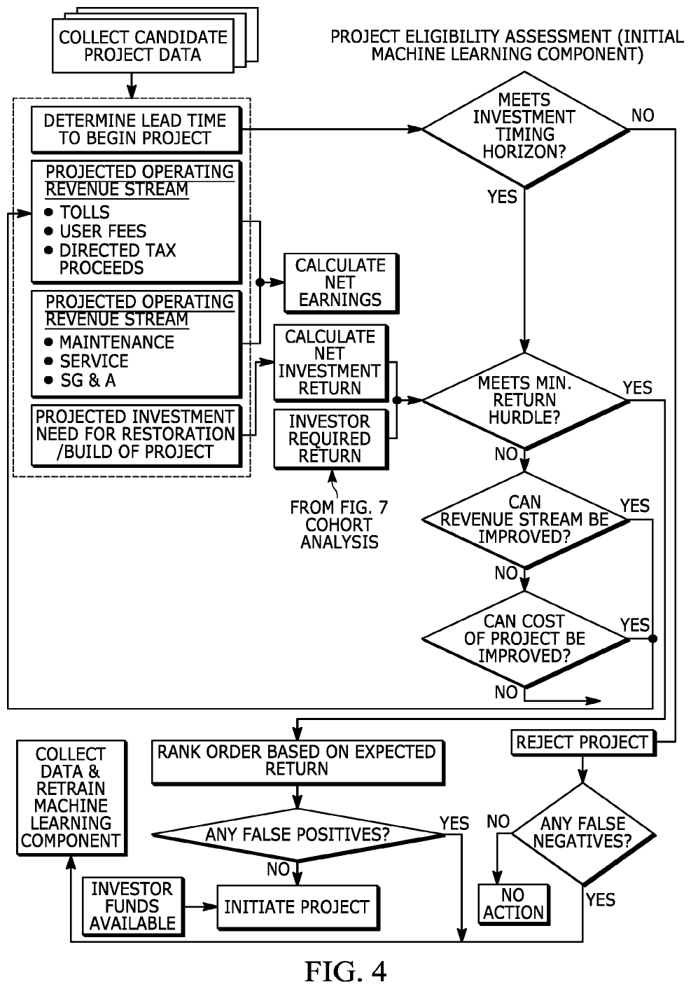

FIG. 4 depicts a flowchart of steps for a project eligibility investment for a long-duration investment in a project for an asset that generates revenue, such as a toll bridge or toll road or a locks system on a river. Initially, the lead time to begin the project may be evaluated to determine if the project even meets the investment's timing horizon. If it does not, the project may be rejected. If it does, then a machine-learning component may be used to provide a further analysis and assessment of the project and investment.

The analysis and assessment may be implemented via a machine-learning based platform comprising computer server(s), computing device(s), or otherwise processor(s) configured with specific software and algorithms for optimizing results. For example, in various aspects, the machine-learning based systems and methods may utilize one or more server(s) that include one or more processors and one or more memories. The server(s) may be configured to receive, via a computer network, one or more search requests of a user, one or more transaction details of the user, and/or profile information of the user. The server(s) may also be configured to generate or update a user profile of the user such that the user profile becomes associated with, for example, in the one or more memories of the server(s), the one or more search requests, the one or more transaction details, and the profile information of the user.

As an initial step, project data is collected for a project candidate. A machine-learning component may be trained, or otherwise configured, based on various data collected relating to the project, to predict net earnings for the project and net investment return for the project. For a projection or prediction of net earnings for the project, the machine-learning component may use a machine learning model trained on collected “project revenue data” such as data relating to projected operating streams, such as tolls, user fees and directed tax proceeds. For a determination or prediction of operating costs for the project, the machine-learning component may use a machine learning model trained on collected “operating costs data”, such as maintenance costs, services costs and selling, general and administrative expenses. For a determination or prediction of net investment return for the project, the machine-learning component may also use a machine learning model trained on collected “investment need” data relating to the cost to build or restore the project, as determined by infrastructure project engineers, design/build firms, engineering consultants or other experts in the field. The predicted “investment need” for the project is then used in combination with the predicted “net earnings” to determine a predicted “net expected return” for the project.

The predicted net investment return can then be compared to the particular investor's requirements for a return on investment to determine if the investment meets the minimum return needed. If the predicted investment return does not meet the investor's minimum investment the data concerning the projected operating revenue and operating costs may be reevaluated and updated to see if they can be improved. Similarly, the data concerning the predicted investment need for a project may be reevaluated to see if it can be improved. If any data is improved, the machine predicted revenue stream may be improved for the project and/or if predicted costs of the project may be improved, and if so, the machine-learning component may be trained, or otherwise configured, to predict, based on the updated information to determine an updated predicted net earnings for the project and net investment return for the project to see if it now meets the investment hurdle. If neither sets of data can be updated or improved, then the project is rejected.

This analysis may be conducted on several projects, some of which may meet the investment hurdle and some of which may not. If the predicted net investment return for a project meets the investment hurdle, then the project may be ranked with other projects that also meet the investment hurdle based on overall expected returns and compared to the other investments with other factors that may also be important to an investor, e.g., overall risk or time horizon. The ranked projects may be checked for false positives, and if any are false positives they are rejected before being presented to an investor. Once investor funds are available for a selected project, the project is initiated. Similarly, any projects that have been rejected may be checked for false negatives. If a false negative is not detected, no action is taken. However, if a false negative is detected, the data may be collected and added to the databases used by the machine-learning components.

Furthermore, once a project is initiated, data from the project relating to the actual operating streams, operating costs and investment needs for building or restoring the project is collected and added to the database used by the machine-learning components so it can be used to improve predictions for future projects and/or make updated predictions for projects that have been implemented.

### Example—Policy Form Customization Model

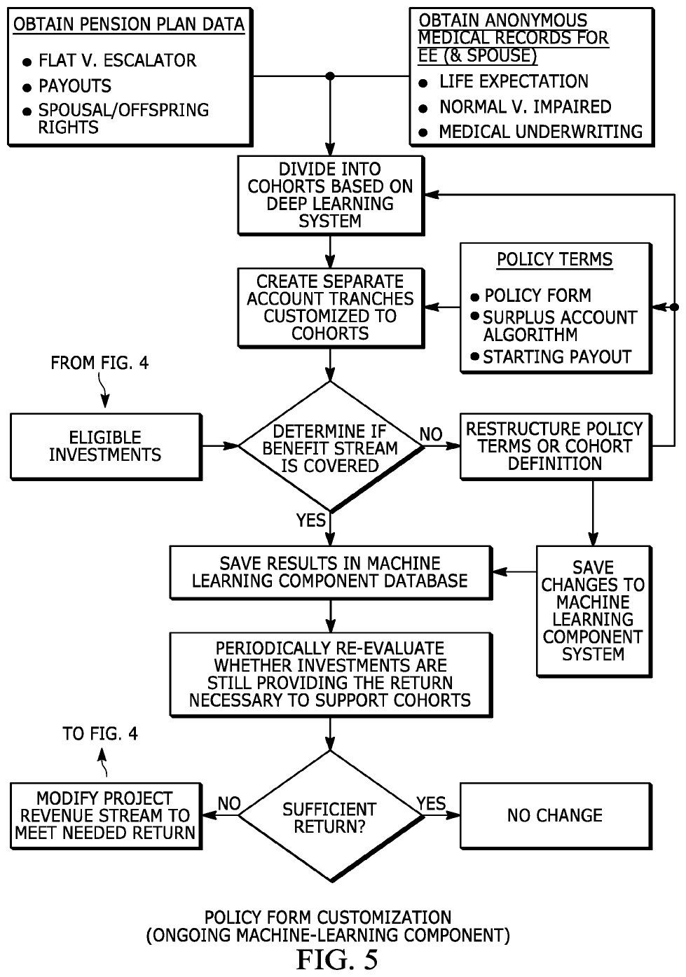

FIG. 5 depicts a flowchart of steps for policy form customization for a certain investor, such as a pension plan, in a project. This customization can be performed on an ongoing basis, e.g., after an investment has been made in a particular project.

Initially, “pension plan data” is collected, such as data concerning whether the pension plan requires flat payments or escalating payments, what the payouts are and whether the plan has spousal or offspring rights in payments after the pension beneficiary dies. Similarly, “medical record data” is collected about pension beneficiaries and their spouses. The medical record data or beneficiary medical data collected may be done on a confidential basis and may include an individual's life expectancy, whether the individual is impaired or not and medical underwriting information.

Further analysis and assessment may be implemented via a machine-learning based platform comprising computer server(s), computing device(s), or otherwise processor(s) for optimizing results, as described above.

As an initial step, the pension beneficiaries may be divided into groups of cohorts. A machine-learning component may be trained, or otherwise configured, to predict, based on various data that has been collected, various tranches of cohort groups within the pension plan. The machine-learning component may use a machine learning model trained on collected “pension plan data” and “medical record data”. The machine-learning component may be trained, or otherwise configured, to predict a “benefit stream” needed for each tranche of cohorts. The machine-learning component may use a machine learning model trained on collected “pension plan data” and “medical record data” as well as “Surplus Account” data and “initial starting payout” data to determine the predicted benefit stream for each tranche of cohorts.

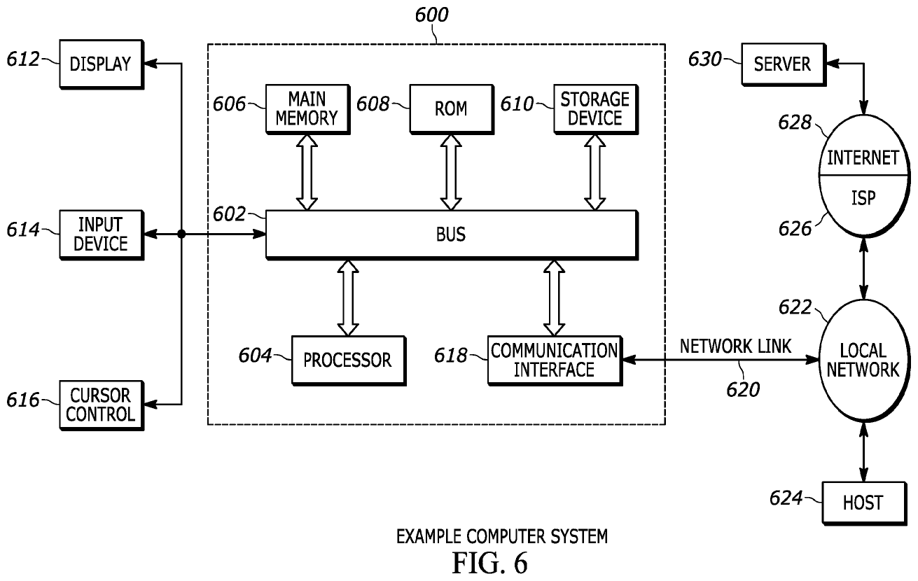

A “Separate Account” may be created for each tranche of cohorts. For each tranche of cohorts, a machine-learning component may evaluate each eligible investment to see if the predicted revenue stream (described above with respect to FIG. 6) for the tranche would cover the predicted benefit stream.

If the predicted revenue stream would not cover the predicted benefit stream for a particular tranche of cohorts, the policy terms may be reviewed or adjusted for restructuring and the cohort groups may be reevaluated and redefined. Once these steps are done, the machine-learning component may re-create new tranches of cohort groups and use a machine learning model to predict a new “benefit stream” for each tranche of cohorts. The predicted revenue stream can be compared to the new benefit stream to see if the tranche's predicted revenue stream would cover the predicted benefit stream.

Once the predicted revenue stream is enough to cover the predicted benefit stream then the results are saved for the various data in a database for the machine-learning component. The updated policy terms and definitions for the updated tranches of cohorts is also saved in the database.

The steps for policy form customization described above may be reevaluated from time to time during the period of the investment, using an optimization component, to determine if the investment is and will continue to provide the returns necessary to support the benefit stream to support each tranche of cohorts. The optimization component is a machine-learning component that may be trained, or otherwise configured, based on various data collected relating to the project, to predict net earnings and revenue streams for the project and net income. If the optimization component determines that the predicted revenue stream will not support the benefit stream needed for the cohorts, then various factors relating to the project, e.g., the project's projected operating revenue stream, projected operating expenses or projected investment need (as described in FIG. 4), may be adjusted appropriately, and the machine-learning component may then be trained, or otherwise configured, to predict, based on various updated data, to predict net earnings for the project and net investment return for the project.

For example, if the project being evaluated is a toll bridge, the revenue stream prediction may be based, in part, on the projected number of tolls per day and the cost of each toll. While conservative numbers may be used for each variable (i.e., lower number of tolls per day and lower toll fees than those actually expected) to evaluate a project initially, those numbers may be revised to be closer to expected numbers. Furthermore, if a shortfall in revenue is predicted, the actual toll fees may be increased to enhance revenue or other user fees may be imposed and the machine-learning component may determine an updated revenue prediction to be evaluated for the investment. Furthermore, a given investment may also have terms that provide for sharing excess revenue with the project's partners or governmental owners and the machine-learning component may use data relating to an allocation of such excess payments to predict the amounts of such payments given a set of data.

Additional Examples of Investments Using a “Surplus Account”

Various types of investments may utilize a Surplus Account, in accordance with the structure and teaching described above. Investments may include those that presently conform to various financial laws and regulations in the United States or other countries, but include the novel use of a Surplus Account. Below are additional examples of use of a Surplus Account in connection with various investments that may be offered within the requirements of the Securities Act of 1933 (referred to as 33 Act) and/or the 1940 Investment Companies Act (the “40 Act”). A Surplus Account can be in a general account or a separate account based on product design.

### Example 1—33 Act—Fair Value Assets—Immediate Variable Annuity

Type of Account for the Surplus Account—The Surplus Account is in the general account of the insurance company.

In this example, the asset value is determined by “fair value” pricing and a methodology will be established to determine pricing. As an example, for a tollway “asset”, the “fair value pricing” may be based on revenues from tolls collected by actual number of cars/trucks that used tollway and the cost of tolls for a period and future anticipated revenues based on expected increases or decreases of the values

The types of assets that can be held in this example are non-registered exempt securities, including, but not limited to:
Public or Private Infrastructure (e.g., locks, dams, roads, bridges, pipelines, etc.)
Large Assets (e.g., buildings, planes, boats, trains, etc.)
Cash Flow Assets (Leases, Life Settlements, Judgement Sales, A/R Factoring, etc.)
Real estate
Alternative investments
Registered funds with fair value pricing

The assets can also be long term or short term.

The “Actual Return” for a period can be determined by the revenue generated by the asset during term (e.g., tolls, rents, user fees, electric charging fees etc.). The Return is then compared to the “cap” and “floor”

When “Actual Returns” are determined and paid to investors may be pre-determined, e.g., they may be set by contract and may also conform with certain legal requirements. For example, in the U.S., returns for immediate variable annuities must begin within 1 year.

The types of investors in this example may be limited, e.g., to non-qualified individuals.

The investment structure may also be limited, e.g., to an Immediate Variable Annuity (with Floor and Cap).

Once the surplus amount in the “Surplus Account” reaches a certain level, the surplus may be:
disbursed to policy holder (non-qualified investor)
disbursed as cash in support of guarantee or enhancement of annual income
accumulated as a death benefit (note: the amount that can be accumulated may be capped)
paid for other benefits such as long or short term care insurance

### Example 2—40 Act—Market Priced Assets (Daily Pricing)—Immediate Variable Annuity

Type of Account for the Surplus Account—The Surplus Account can be a separate account, specifically, a fund held by a life insurance company that is maintained separately from the insurer's general assets. In this example, the investor has all of the portfolio risk, but any guarantees on returns will come from the insurance company's general account.

In this example, the asset value is determined by “daily” pricing.

The types of assets that can be held in this example are registered securities, such as:
Stock
Bonds
ETFs
Mutual Funds
Derivatives

The “Actual Returns” for a period can be determined by the value of stock/bonds, plus any income received (dividends and interest), at designated time. The Return is then compared to the “cap” and “floor”.

When “Actual Returns” are determined and paid to investors may be pre-determined, e.g., they may be set by contract and may also conform with certain legal requirements. For example, in the U.S., returns for immediate variable annuities must begin within 1 year.

The types of investors in this example may be limited, but may include individuals, corporations (including, LLCs, associations, trusts, estates, etc.) buying for the benefit of an individual annuitant (for example, as deferred compensation).

The investors may be onshore or offshore investors.

The investment structure may also be limited, e.g., to an Immediate Variable Annuity (with Floor and Cap).

Once the surplus amount in the “Surplus Account” reaches a certain level, the surplus may be:
disbursed to policy holder (non-qualified investor)
disbursed as cash in support of guarantee or enhancement of annual income
accumulated as a death benefit (note: the amount that can be accumulated may be capped)
paid for other benefits such as long term care insurance

### Example 3—40 Act—Fair Value Assets—Immediate Variable Annuity Version

Type of Account for the Surplus Account—The Surplus Account can be a separate account, that is a non-registered, exempt security offered by a plan sponsor as an option inside a 401(k) or other qualified defined benefit plan.

In this example, the asset value is determined by “fair value” pricing and a methodology will be established to determine pricing. As an example, for a tollway “asset”, the “fair value pricing” may be based on revenues from tolls collected by actual number of cars/trucks that used tollway and the cost of tolls for a period and future anticipated revenues based on expected increases or decreases of the values.

The types of assets that can be held in this example are non-registered exempt securities, including, but not limited to:
Public or Private Infrastructure (e.g., locks, dams, roads, bridges, pipelines, etc.)
Large Assets (e.g., buildings, planes, boats, trains, etc.)
Cash Flow Assets (Leases, Life Settlements, Judgement Sales, A/R Factoring, etc.)
Real estate
Alternative investments

The assets can also be long term or short term.

The “Actual Returns” for a period can be determined by the revenue generated by the asset during term (e.g., tolls, rents, user fees, electric charging fees etc.). The Return is then compared to the “cap” and “floor”.

When “Actual Returns” are determined and paid to investors may be pre-determined, e.g., they may be set by contract and may also conform with certain legal requirements. For example, in the U.S., returns for immediate variable annuities must begin within 1 year.

In this example, earnings accrue to the account when earned. For example, for an investment in a toll bridge to be built that takes 2 years to build, there would be no earnings until the bridge opens and begins collecting tolls in year 3.

The types of investors in this example may be limited, e.g., to institutional, plan sponsors only.

Investors may also include:
Sovereign wealth funds
Offshore institutional private placement
Onshore of Offshore investors

The investment structure may also be limited, e.g., to an Immediate Variable Annuity (with Floor and Cap).

Once the surplus amount in the “Surplus Account” reaches a certain level, the surplus may be:
disbursed to policy holder (non-qualified investor)
disbursed as cash in support of guarantee or enhancement of annual income
accumulated as a death benefit (note: the amount that can be accumulated may be capped)
paid for other benefits such as long term care insurance

### Example 4—40 Act—Fair Value Assets—Accumulation Version

Type of Account for the Surplus Account—The Surplus Account can be a separate account, that is a non-registered, exempt security offered by a plan sponsor as an option inside a 401(k) or other qualified defined benefit plan.

In this example, the asset value is determined by “fair value” pricing and a methodology will be established to determine pricing. As an example, for a tollway “asset”, the “fair value pricing” may be based on revenues from tolls collected by actual number of cars/trucks that used tollway and the cost of tolls for a period and future anticipated revenues based on expected increases or decreases of the values.

The types of assets that can be held in this example are non-registered exempt securities, including, but not limited to:
Public or Private Infrastructure (e.g., locks, dams, roads, bridges, pipelines, etc.)
Large Assets (e.g., buildings, planes, boats, trains, etc.)
Cash Flow Assets (Leases, Life Settlements, Judgement Sales, A/R Factoring, etc.)
Real estate
Alternative investments

The assets can also be long term or short term.

The “Actual Returns” for a period can be determined by the revenue generated by the asset during term (e.g., tolls, rents, user fees, electric charging fees etc.). The Return is then compared to the “cap” and “floor”.

When “Actual Returns” are determined and paid to investors may be pre-determined, e.g., they may be set by contract and may also conform with certain legal requirements. For example, in the U.S., returns for immediate variable annuities must begin within 1 year.

The types of investors in this example may be limited, e.g., to institutional, plan sponsors only.

Investors may also include:
Sovereign wealth funds
Offshore institutional private placement
Onshore of Offshore investors

The investment structure may also be limited, e.g., to an Immediate Variable Annuity (with Floor and Cap).

Once the surplus amount in the “Surplus Account” reaches a certain level, the surplus may be disbursed all or in part to:
a policy holder
investors
a State and/or local government
a plan administrator
another person or entity

Additional Examples of Uses of AI and Machine Learning

AI and machine learning can be applied in the healthcare area and environmental areas to help better define investment structures and better price investments for investors.

For example in healthcare, AI can be used to create a model that can move a pension fund from a traditional “pooled” risk approach to an “individual” risk approach. By using a model that can evaluate risk for a group of beneficiaries on an individual basis, a pension fund may be able to reduce its obligations by 5-10%. For example by looking at information in the known EPIC system, for example, the specific ages, health conditions, and/or medications (and a number of other factors in the EPIC system) for each individual in the group, a model can be built that provides a more accurate prediction of how much revenue will be needed over time by the pension fund.

As another example, AI may be used to create a model that can evaluate or predict the environmental impact of proposed projects in an effort to reduce the cost structure and/or reduce the liability for a particular new project. The model can be based on historical data about the actual impact on various environmental conditions from various previous projects. For example, the model may predict of the impact of a new toll road's effect on travel and wait times, reduced gas usage and CO2 emissions, for various possibilities, e.g., if a 3 lane expansion or a 5 lane expansion. The model will then predict the impact for each, and the impact can be used to compare future cost and/or return on investment of the project and/or to propose projects to be built and to price investments for future projects.

### Specific Examples of Uses of AI and Machine Learning for Investments that can Use a “Surplus Account”

### Specific Example 1—Uses for Examples Above Relating to

33 Act—Fair Value Assets—Immediate Variable Annuity,

40 Act—Fair Value Assets—Immediate Variable Annuity version, and

40 Act—Fair Value Assets—Accumulation version

By an Insurance Company, prior to investment, to improve and optimize predictions of anticipated revenue and returns for a project. It can be used to help set initial contract terms for the investment in the project (e.g., uses for the surplus account and the level of surplus account to maintain). Some projects may require increases tied to inflation, some may have fixed percentage automatic increases, some have no increases in order to match retirement payout benefit obligations.

By a Plan Sponsor, prior to investment, to improve and optimize predictions of anticipated needed revenue and returns on investment over time (based on information collected from other investment sources, e.g., EPIC database and information about plan participants).

By an Insurance Company, during the term of an investment, to improve and optimize predictions of anticipated needed revenue and returns on investment over time (based on information collected from other investment sources, e.g., EPIC database and information about plan participants).

By an Advisor, during the term of an investment, to optimize any needed revenue adjustments (tolls/fees/etc.).

### Specific Example 2—Uses for Examples Above Relating to

40 Act-Market Priced Assets (Daily Pricing)-Immediate Variable Annuity

By an Insurance Company, prior to investment, to improve and optimize predictions of anticipated revenue and returns for an investment. It can also help the insurance company set initial contract terms for the annuity (e.g., uses for the surplus account and the level of surplus account to maintain).

By an Insurance Company, during the term of an investment, to improve and optimize predictions of anticipated revenue and returns for an investment.

AI and machine-learning applications for the examples described herein, may relate to:

Asset Performance Optimization: predicting financials associated with a project, based on developments around revenue/cost experience.

Tailoring and Matching of Investment: Using inputs to optimize selection of projects and the structure of the investment to investors needs

Enhanced Actuarial-Based Investing: Improvement of Pension ALM matching based on dynamic life and medical underwriting.

Hardware and Software Overview

In certain embodiments, execution of one or more steps may be automated on a computer system, which can be, for example, a mainframe computer, minicomputer, workstation, personal computer, a web server, a thin client, and an Internet appliance. FIG. 6 is a block diagram that illustrates a computer system 600 upon which an embodiment of the invention may be implemented. Computer system 600 includes a bus 602 or other communication mechanism for communicating information, and a processor 604 coupled with bus 602 for processing information. Computer system 600 also includes a main memory 606, such as a random-access memory (RAM) or other dynamic storage device, coupled to bus 602 for storing information and instructions to be executed by processor 604. Main memory 606 also may be used for storing temporary variables or other intermediate information during execution of instructions by processor 604. Computer system 600 further includes a read only memory (ROM) 608 or other static storage device coupled to bus 602 for storing static information and instructions for processor 604. A storage device 610, such as a magnetic disk or optical disk, is provided and coupled to bus 602 for storing information and instructions.

Computer system 600 may be coupled via bus 602 to a video display 612 for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

One embodiment of the invention is related to the use of computer system 600 for training. According to one embodiment of the invention, training is provided by computer system 600 in response to processor 604 executing one or more sequences of one or more instructions contained in main memory 606. Such instructions may be read into main memory 606 from another computer-readable medium, such as storage device 610. Execution of the sequences of instructions contained in main memory 606 causes processor 604 to perform the process steps described herein. One or more processors in a multi-processing arrangement may also be employed to execute the sequences of instructions contained in main memory 606. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 604 for execution. Such a medium may take many forms, including but not limited to, non-volatile media, volatile media, and transmission media. Non-volatile media include, for example, optical or magnetic disks, such as storage device 610. Volatile media include dynamic memory, such as main memory 606. Transmission media include coaxial cables, copper wire and fiber optics, including the wires that comprise bus 602. Transmission media can also take the form of acoustic or light waves, such as those generated during radio frequency (RF) and infrared (IR) data communications. Common forms of computer-readable media include, for example, a thumb drive, cloud storage, any optical medium, a RAM, a PROM, an EPROM, a FLASH-EPROM, any other memory chip, a carrier wave as described hereinafter, or any other medium from which a computer can read.

Various forms of computer readable media may be involved in carrying one or more sequences of one or more instructions to processor 604 for execution. For example, the instructions may initially be on a magnetic disk of a remote computer. The remote computer can load the instructions into its dynamic memory and send the instructions over a telephone line using a modem. A modem local to computer system 600 can receive the data on the telephone line and use an infrared transmitter to convert the data to an infrared signal. An infrared detector coupled to bus 602 can receive the data carried in the infrared signal and place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card or a modem to provide a data communication connection to a corresponding type of telephone line. As another example, communication interface 618 may be a local area network (LAN) card to provide a data communication connection to a compatible LAN. Wireless and fiber optic links may also be implemented. In any such implementation, communication interface 618 sends and receives electrical, electromagnetic or optical signals that carry digital data streams representing various types of information.

Network link 620 typically provides data communication through one or more networks to data bases hosted on other data devices. For example, network link 620 may provide a connection through local network 622 to a host computer 624 or to data equipment operated by an Internet Service Provider (ISP) 626. ISP 626 in turn provides data communication services through the worldwide packet data communication network, now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are exemplary forms of carrier waves transporting the information.

Computer system 600 can send messages and receive data, including program code, through the network(s), network link 620, and communication interface 618. In the Internet example, a server 630 might transmit a requested code for an application program through Internet 628, ISP 626, local network 622 and communication interface 618. In accordance with the invention, one such downloaded application provides for administering and financing investment contracts as described herein. The received code may be executed by processor 604 as it is received, and/or stored in storage device 610, or other non-volatile storage for later execution. In this manner, computer system 600 may obtain application code in the form of a carrier wave.

The invention claimed is:

1. A machine-learning based system configured to optimize investment returns for a revenue generating investment based upon retirement benefit plan information, the machine-learning based system comprising:
a server, the server including one or more processors and one or more memories, the server configured to receive, via a computer network, one or more search requests of a user, and profile information of the investment, wherein the server is further configured to generate or update an investment profile for the investment, wherein the investment profile is associated with, in the one or more memories, the one or more search requests;
a machine-learning component configured to execute on the one or more processors of the server, the machine-learning component further configured to train a machine learning model using a machine-learning feature dataset comprising each of: projected operating revenue information, projected operating cost information and projected investment need information, to generate, with the machine-learning feature dataset, each of (1) net return and (2) a machine-learning ranking of the investment; and
a machine-learning component configured to execute on the one or more processors of the server, the machine-learning component further configured to train a machine learning model using a machine-learning feature dataset comprising each of: pension plan data and beneficiary medical data, to generate, with the machine-learning feature dataset, each of (1) tranches of cohorts of beneficiaries and (2) a machine-learning analysis of the benefit stream needed to meet the payments to each tranche of cohorts; and
an optimization component configured to execute on the one or more processors of the server, the optimization component further configured to receive updated operating revenue information and updated operating cost information to generate updated net earnings and updated net investment return information;
wherein the generation of the updated net earnings and updated net investment return information causes the server, to transmit, via the computer network, the updated plan information to a user.

2. The system of claim 1 wherein pension plan data includes data concerning whether the pension plan requires flat payments or escalating payments, what the payouts are and whether the plan has spousal or offspring rights in payments after the pension beneficiary dies.

3. The system of claim 1 wherein the beneficiary medical data includes a beneficiary's life expectancy, whether the beneficiary is impaired and medical underwriting information relating to the beneficiary.

4. The system of claim 1 wherein projected operating revenue dataset information includes tolls, user fees or direct tax proceeds.

5. The system of claim 1 wherein projected operating cost dataset information includes as maintenance costs, services costs and selling, general and administrative expenses for the investment.

6. The system of claim 1 wherein the investment is a long-duration asset.

7. The system of claim 6 wherein the long-duration asset is a large infrastructure asset that generates revenue.

8. The system of claim 1 wherein the investment is a toll bridge, a toll road or lock system.

9. The system of claim 1 wherein the investment is offered through a separate account created for one or more investors at a life insurance company.

10. The system of claim 9 wherein a surplus account is also associated with the investment and the system increases or decreases the amount of the surplus account based on the actual return of the investment for a given period.

11. A computer implemented method of optimizing investment returns for a revenue generating investment based upon retirement benefit plan information, on one or more computer servers having processors, comprising the steps of:
receiving, at a server, one or more search requests of a user, and profile information of the investment,
generating or updating, on a server, an investment profile for the investment, wherein the investment profile is associated with, in the one or more memories, the one or more search requests;
executing on a server, a machine learning component configured to train a machine learning model using a machine-learning feature dataset comprising each of: projected operating revenue information, projected operating cost information and projected investment need information, to generate, with the machine-learning feature dataset, each of (1) net return and (2) a machine-learning ranking of the investment; and
executing on a server, a machine-learning component configured to train a machine learning model using a machine-learning feature dataset comprising each of: pension plan data and beneficiary medical data, to generate, with the machine-learning feature dataset, each of (1) tranches of cohorts of beneficiaries and (2) a machine-learning analysis of the benefit stream needed to meet the payments to each tranche of cohorts; and
receiving, at an optimization component on a server, updated operating revenue information and updated operating cost information to generate, at the server, updated net earnings and updated net investment return information;
wherein the generation of the updated net earnings and updated net investment return information causes the server, to transmit, via the computer network, the updated plan information to a user.

12. The method of claim 11 wherein pension plan data includes data concerning whether the pension plan requires flat payments or escalating payments, what the payouts are and whether the plan has spousal or offspring rights in payments after the pension beneficiary dies.

13. The system of claim 11 wherein the beneficiary medical data includes a beneficiary's life expectancy, whether the beneficiary is impaired and medical underwriting information relating to the beneficiary.

14. The system of claim 11 wherein projected operating revenue dataset information includes tolls, user fees or direct tax proceeds.

15. The system of claim 11 wherein projected operating cost dataset information includes as maintenance costs, services costs and selling, general and administrative expenses for the investment.

16. The system of claim 11 wherein the investment is a long-duration asset.

17. The system of claim 16 wherein the long-duration asset is a large infrastructure asset that generates revenue.

18. The system of claim 11 wherein the investment is a toll bridge, a toll road or lock system.

19. The system of claim 11 wherein the investment is offered through a separate account created for one or more investors at a life insurance company.

20. The system of claim 19 wherein a surplus account is also associated with the investment and the system increases or decreases the amount of the surplus account based on the actual return of the investment for a given period.
